(19) United States
(12) Patent Application Publication
(10) Pub. No.: US 2011/0265903 A1
(43) Pub. Date: Nov. 3, 2011

(54) TUBE-SHAPED BODY FOR CONVEYING SOLID, LIQUID AND/OR GASEOUS SUBSTANCES

(75) Inventors: Wolfgang GREINER, Oberdanegg (AT); Stefan POLLASCHEK, Traiskirchen (AT)

(73) Assignee: SEMPERIT AG HOLDING, Wien (AT)

(21) Appl. No.: 13/090,747

(22) Filed: Apr. 20, 2011

(30) Foreign Application Priority Data
Apr. 29, 2010 (DE) 10 2010 018 799.2

(51) Int. Cl. F16L 11/20; F16L 11/00

(52) U.S. Cl. 138/130; 138/153

(57) ABSTRACT

A tube-shaped body for conveying solid, liquid and/or gaseous substances, including a plurality of concentrically arranged layers, where at least one layer is designed as a carrier layer, and at least two further layers are designed as strength layers, which are formed of filamentary and/or wire-shaped and/or elongate components, which each form a structure having a defined structural angle, where at least two strength layers differ in their structural angles.

### TECHNICAL FIELD

The invention relates to a tube-shaped body for conveying solid, liquid and/or gaseous substances, comprising a plurality of concentrically arranged layers. At least one layer is a carrier layer and at least two further layers are strength layers.

### BACKGROUND

Tube-shaped bodies, in particular hoses, are employed in a plethora of fields. They are employed as hydraulic or washing devices hoses, for example. They can also be employed for conveying foodstuffs, mineral oil, steamed hot water, chemicals, industrial water, compressed air or gas. Hoses have to exhibit a certain flexibility so as to withstand the bending load the as well as an internal pressure. Tubes, in contrast, are usually not bendable, however, it is also conceivable to provide tubes which expand due to an internal pressure. Therefore, such tube-shaped bodies are formed from elastic materials so as to exhibit these flexibilities. However, a tube-shaped body usually has to withstand loads from the inside and from the outside so that a tube-shaped body often has inserts which increase its strength. An insert can also increase the required cross-sectional stability. In order to withstand the static and dynamic pressures inside of a tube-shaped body, such inserts may consist of several layers. It is known to concentrically arrange several braided layers in a tube-shaped body so that it can withstand the internal pressure. However, the load on said individual layers differs from layer to layer. Thus, individual layers prematurely suffer fatigue fractures so that the stability of the entire tube-shaped body is impaired, which leads to signs of wear.

### BRIEF SUMMARY

The invention provides a tube-shaped body which withstands increased internal pressures and which can have a longer service life.

The tube-shaped body according to the invention serves to convey solid, liquid and/or gaseous substances and comprises a plurality of concentrically arranged layers. At least one layer is a carrier layer and at least two further layers are strength layers, each of which is formed of filamentary and/or wire-shaped and/or elongate components, which each form a structure having a defined structural angle. At least two strength layers differ in their structural angles. The filamentary and/or wire-shaped and/or elongate components of the structure can be made of various textiles such as nylon, steel wire or a combination of these materials. One strength layer can be surrounded by a carrier layer but it can also surround a carrier layer. The structural angle is formed by the axis of symmetry of the tube-shaped body and the orientation of the structure relative thereto. The strength layers in particular take up the internal pressure which acts perpendicularly to the structural surface and, thus, enhance the strength when the tube-shaped body expands. If two strength layers have different structural angles, said layers, in accordance with their inner and outer position, can take up the stresses caused by the internal pressure in equal measure. The even load on at least two strength layers does not lead to a one-sided strain and prevents that weak spots are formed in the tube-shaped body, which weak spots might lead to a fracture or burst. Thus, the service life of the tube-shaped body is drastically increased. Furthermore, increased internal pressures can be applied. The structure can be a braid or have a spiral configuration, for example.

Preferably, at least one carrier layer of the tube-shaped body comprises a resilient or flexible, in particular viscoelastic material. Thus, the carrier layer contributes to the pressure resilience of the tube-shaped body and fulfills the requirements of a hose also with respect to bending.

Preferably, the strength layers are surrounded by at least one inner carrier layer and/or at least one outer carrier layer. An inner carrier layer is an inner part and and a contact element to the stuff to be conveyed, for example, and can have the required properties with regard to resistance, hygiene and stability. An outer carrier layer is a protection from outer influencers) or a layer having decorative purposes, for example. The strength layers are arranged preferably between said two carrier layers, and can also comprise further intermediate layers, such as a third carrier layer. The strength layers are thus protected from influences by the stuff to be conveyed or from environmental influences and, thus, can be selected particularly with a view to increasing the stability of the hose or tube.

Preferably, an inner strength layer has a smaller structural angle than an outer strength layer. The internal pressure of the tube-shaped body puts more load on the inside of the body than on its outside. The components of the structure experience the maximum load in the innermost layer. Thus, the wire tension can be homogenized if the inner structure has a smaller structural angle than one or more outer strength layers.

According to this embodiment, the tube-shaped body comprises at least three strength layers. An increase in the number of strength layers increases both the stability against internal pressure and the stability of the tube-shaped body against external influences.

Preferably, a first strength layer has a base angle as a structural angle, a second strength layer has a structural angle smaller than the base angle, a third strength layer has a structural angle larger than the base angle. The size of the base angle serves as a reference with respect to the further structural angles. Thus, this tube-shaped body comprises three strength layers which are tuned to each other and, thus, allow for an optimal distribution of stresses throughout all layers.

Preferably, the base angle is in the range of about 50° to 60°, preferably about 53° to 56° and particularly preferably about 54.7°. These values correspond to a preferred size of the structural angle when using a single-layered braided hose and, thus, preferably serve as an approximate value or reference value.

Thus, the structural angle of a the second strength layer, for example, is in the range of about 45° to 55°, preferably about 50° to 52°, and particularly preferably about 51°. The structural angle of the third strength layer is then in the range of about 54° to 60°, preferably about 55° to 57°, and particularly preferably about 56°. These ranges are tuned with regard to the individual layers and can vary depending on the material and position of the layers. Within this range, there is thus achieved for a multitude of arrangements of the strength layers an optimal tuning of the layers to each other and, thus, an even distribution of stresses and, thus, a minimization of the maximally occurring stresses in the structure.

Particularly preferably, the first strength layer is arranged between the two further strength layers. The second strength layer is arranged inside of the two other strength layers, and the third strength layer is arranged outside of the two other strength layers. This is desirable since this leads to a distribution of the stresses to the suitable spots, and, thus, the service life of the tube-shaped body is optimized.

According to another embodiment, the structural angle of a structure is in the range of 35° to 75°. Thus, the strength layers can be tuned to each other and the angles can be optimally adjusted, depending on the number of strength layers, the positions of the strength layers, the distances between the individual strength layers and the requirements of the tube-shaped bodies.

For example, a hose or a ring-shaped body, respectively, comprises four strength layers, wherein said layers have a structure with respective angles of about 52°, about 53°, about 55° and about 56°.

Particularly preferably, the diameter of the filamentary and/or wire-shaped and/or elongate components of all strength layers has approximately the same size. As a result, the same materials can be used in the manufacture of the structures, and the requirements on the manufacture and the load on the structure are defined if no layer has additional requirements on the diameter of the filamentary, wire-shaped or elongate components since the stresses in the components have already been minimized or evenly distributed to the individual layers. Therefore, material and costs for the structural components can be saved. Likewise, the place requirement of a structure decreases, which, in turn, leads to an optimization of the total diameter of the tube-shaped body due to a reduced wall thickness.

Further advantages and features of the invention result from the following description of preferred embodiments with reference to the figures, wherein individual features of different embodiments can be combined to form new embodiments.

### BRIEF DESCRIPTION OF THE DRAWINGS

FIG. 1 schematically shows a perspective view of an embodiment of a tube-shaped body.

FIG. 2 schematically shows a cut-out of a cross-section of an embodiment of the tube-shaped body.

FIG. 3 schematically shows a side view of an embodiment of a strength layer.

FIG. 4 shows a cut-out of an embodiment of a strength layer.

FIG. 5 shows a diagram for the distribution of stresses of the strength layers in an embodiment.

### DETAILED DESCRIPTION

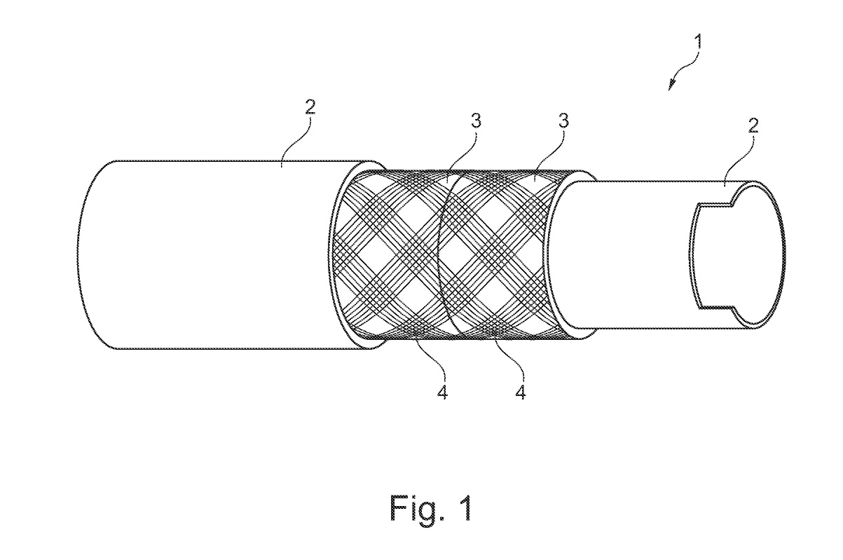

Identical reference signs are used to denote identical parts in the figures. The tube-shaped body 1 shown in FIG. 1 has four layers. The carrier layers 2 are arranged both on the inside and on the outside. The strength layers 3 are arranged between the carrier layers 2. The strength layers are formed from a structure 4 which serves as strength carrier for the tube shaped body. The inner carrier layer 2 is adapted to the requirements of the stuff to be conveyed, and the outer carrier layer 2 is adapted to the requirements made from the outside on the body 1 by the external influences. Here, the strength layers 3 are protected by the material of the carrier layer and can withstand the pressure requirements since they are damaged neither from the inside nor from the outside.

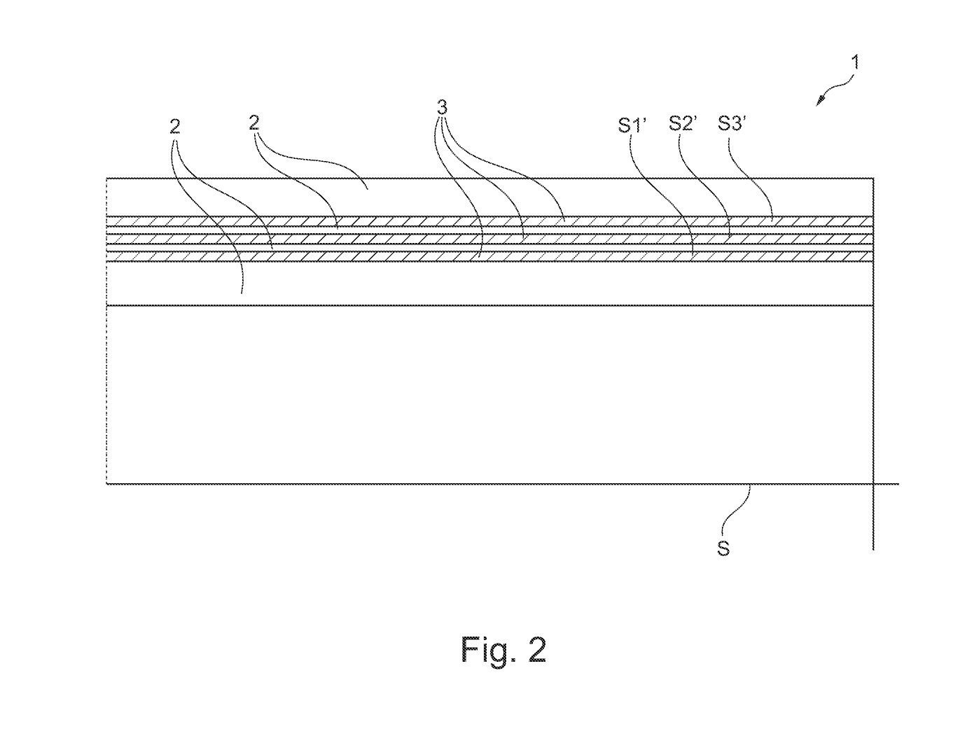

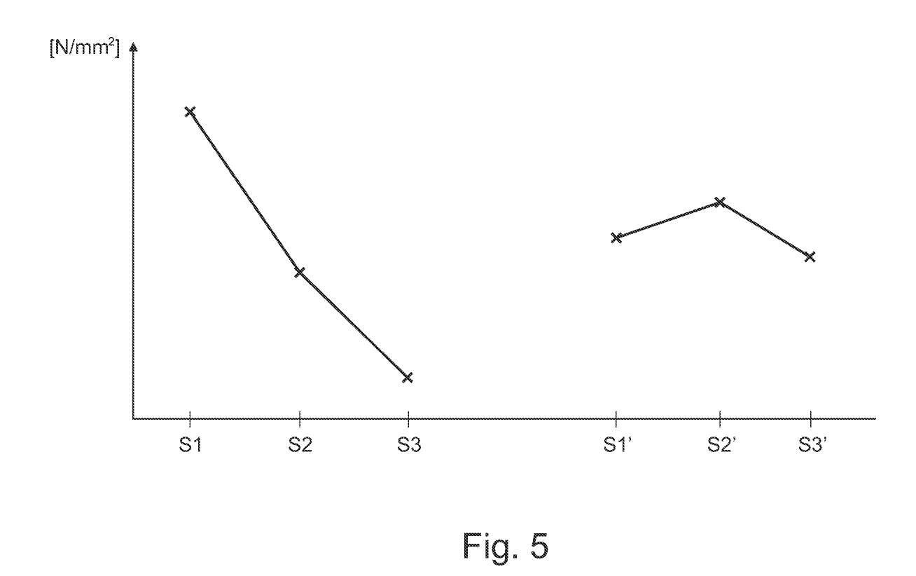

FIG. 2 shows a cut-out of the cross-section of an embodiment of a tube-shaped body 1. Said body 1 has an inner and an outer carrier layer 2 and, arranged between said layers, three strength layers 3. Between the strength layers 3, there are further carrier layers 2. Said carrier layers 2 serve as intermediate layers. All layers are arranged concentrically to each other and form the tube or hose, respectively. The strength layers 3 form an inner strength layer S1′, a middle strength layer S2′, and an outer strength layer S3′, which will be described in more detail with respect to FIG. 5.

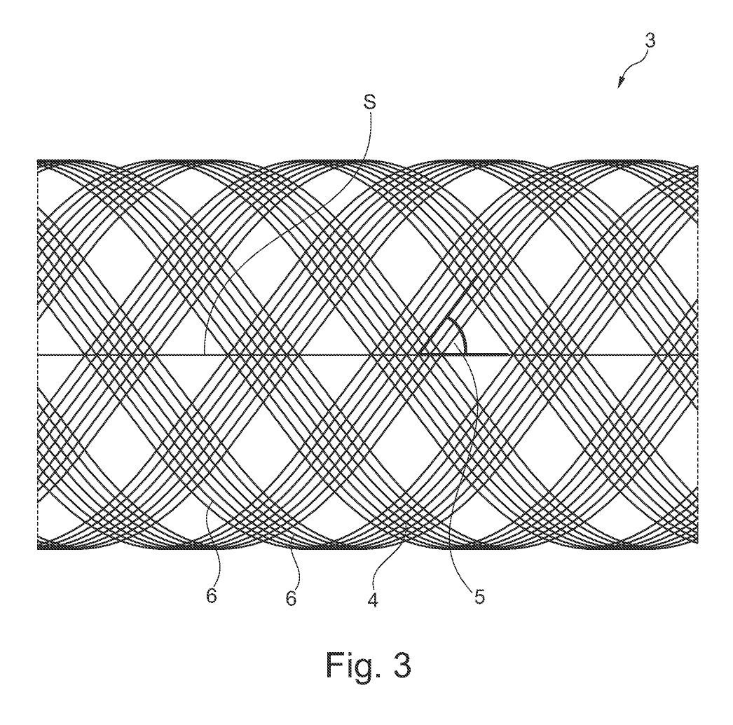

FIG. 3 shows a side view of a strength layer 3. The braid 4 is formed by filamentary components 6. Said components 6 are arranged at defined distances and, thus, at defined angles from each other. The structure has a structural angle 5 which is formed by the axis of symmetry S of the tube-shaped body 1 and the orientation of the filamentary or wire-shaped or elongate components 6 of the structure 4.

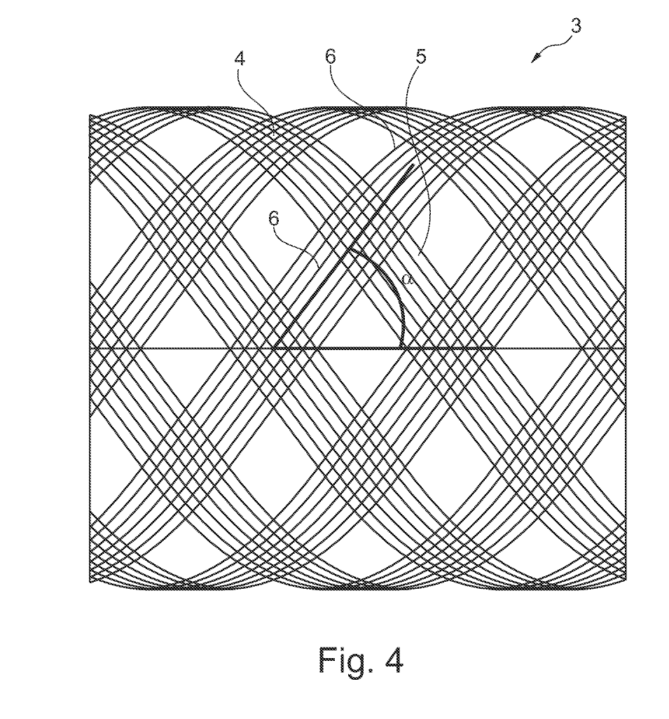

FIG. 4 shows an enlarged cut-out of the strength layer 3 such that the structural angle 5 of the structure 4 is better visible. The structural angle 5 is formed by the axis of symmetry S of the tube-shaped body and the orientation of the filamentary or wire-shaped or elongate components 6 thereto. The structural angle 5 can vary in a range between more than 0° and smaller than 90°.

FIG. 5 shows the distribution of stresses in the individual strength layers 3 with varying structural angles 5 compared to corresponding strength layers 3 without varying braid angle 5. The layers S1′, S2′, S3′ correspond to the layers from FIG. 2 and have structural angles 5 which are tuned to each other and which differ from each other. Here, the stress in the strength layer S1′, S2′, S3′ remains essentially the same. In comparison, three strength layers S1, S2, S3 are shown, whose arrangement corresponds to the strength layers of FIG. 2, however, which all have the same structural angle 5. Due to the greater load on the layer S1 said layer is subjected to a greater stress in the components 6 of the structure than the layers S2 and S3. The layer S3 is subjected to the least stress and can contribute the least to the pressure stability of the tube-shaped body 1.

1. A tube-shaped body for conveying solid, liquid and/or gaseous substances, comprising:
a plurality of concentrically arranged layers,
wherein at least one layer is designed as a carrier layer, and at least two further layers are designed as strength layers, which are formed of filamentary and/or wire-shaped and/or elongate components, which each form a structure having a defined structural angle,
wherein at least two strength layers differ in their structural angles.

2. The tube-shaped body of claim 1, wherein at least one carrier layer comprises a flexible material.

3. The tube-shaped body of claim 1, wherein the strength layers are surrounded by at least one inner carrier layer and/or at least one outer carrier layer.

4. The tube-shaped body of claim 1, wherein at least one carrier layer is arranged between at least two strength layers.

5. The tube-shaped body of claim 1, wherein an inner strength layer has a smaller structural angle than an outer strength layer.

6. The tube-shaped body of claim 1, wherein said body comprises at least three strength layers.

7. The tube-shaped body of claim 6, wherein the first strength layer has a base angle as structural angle, a second strength layer has a structural angle smaller than the base angle, and a third strength layer has a structural angle larger than the base angle.

8. The tube-shaped body of claim 7, wherein the base angle is in the range of about 50° to 60°.

9. The tube-shaped body of claim 7, wherein the structural angle of the second strength layer is in the range of about 45° to 55°, and the structural angle of the third strength layer is in the range of about 54° to 60°.

10. The tube-shaped body of claim 7, wherein the first strength layer is arranged between the two further strength layers, the second strength layer is arranged on the outside of the two other strength layers, and the third strength layer is arranged on the inside of the two other strength layers.

11. The tube-shaped body of claim 1, wherein the structural angle of a structure is in the range of 35° to 75°.

12. The tube-shaped body of claim 1, wherein the diameter of the filamentary and/or wire-shaped and/or elongate components of all strength layers is approximately the same.
